(19) United States
(12) Patent Application Publication
(10) Pub. No.: US 2002/0065665 A1
(43) Pub. Date: May 30, 2002

(54) Digital data decompressing system and method

(75) Inventors: Hiroyuki Hamasaki, Kodaira (JP); Takashi Miyamoto, Kodaira (JP); Hiroshi Takeda, Higashiyamato (JP); Jun Sato, Mitaka (JP); Kenichiro Omura, Higashimurayama (JP); Kazushige Ayukawa, Kokubunji (JP)

Correspondence Address: Stanley P. Fisher, Reed Smith Hazel &Thomas LLP, Suite 1400, 3110 Fairview Park Drive, Falls Church, VA, 22042-4503, US

(73) Assignee: Hitachi, Ltd.

(21) Appl. No.: 09/977,334

(22) Filed: Oct. 16, 2001

(30) Foreign Application Priority Data
Oct. 17, 2000 (JP) 2000-316093

(51) Int. Cl. H04N 11/02; H04N 9/00; H04N 9/79; H04N 11/04; G06F 17/00; H04N 7/12; G10L 19/00; G10L 21/00

(52) U.S. Cl. 704/500; 386/33; 386/39; 386/40; 348/384.1; 700/94

(57) ABSTRACT

In a system that decompresses data compressed in compliance with the MPEG or JPEG standard, a buffer memory (603) to store values computed during decompression of the compressed data is split to plural banks (BNK); each of the banks is provided with an all-zero flag (AZF) indicating whether data within the bank is all “0”s; when data to be written to a bank is all “0”s, the all-zero flag is set without performing actual writing to the buffer memory; and during data reading, the flag is sensed to see if data within the bank is all “0”s, at which time reading from the buffer memory is omitted.

### BACKGROUND OF THE INVENTION

1. Field of the Invention

The present invention relates to a technique for decompressing compressed data, and more particularly to a technique effectively used for an audio reproducing system that decompresses audio data compressed in compliance with, e.g., the MPEG1 audio standard, and an image data reproducing system that decompresses image data compressed in compliance with the JPEG standard.

2. Description of the Prior Art

The MPEG1 audio standard is a set of international standards established by the International Organization for Standardization, and is a technique relating to compression and decompression of audio data. Since data compressed and decompressed in compliance with the MPEG audio standard is less susceptible to deterioration of sound quality and is greatly reduced in data quantity, it is being used in portable audio reproducing apparatuses such as MP3 players.

Hereinafter, with the MPEG1 layer III as an example, a decoding processing procedure for decompressing compressed audio data will be described using FIG. 17.

Compressed audio data is supplied to a decompressing system as serial data called a bit stream. The bit stream is a time series arrangement of data called frames of a predetermined format, the frames each containing a header, format information, an error check code, bit allocation information, scale factor information, subband sample data, and like.

The subband sample data is separated to a block split every given time (8 ms) of an input signal wherein the block data is split to 32 frequency bands and compressed through modified discrete cosine transform (MDCT), nonlinear quantization, and Huffman encoding. Compressed data of one block of subband sample data is provided with a header, format information, an error check code, bit allocation information, and scale factor information, and these elements are arranged in a predetermined order, constituting one frame. An arrangement of the frames occurring consecutively in time series is a bit stream.

In decompression processing, as shown in FIG. 17, sample data is extracted from a bit stream BS, and data having been encoded to variable-length codes such as Huffman codes in compression processing is decoded (step S1) to obtain sample data SPL1 to SPL32 of 32 mutually different frequency bands. The decoded sample data SPL1 to SPL32 are respectively subjected to dequantization processing using a dequantization table to restore them as they were before being quantized (step S2). Thereafter, after frequency to time space conversion processing (step S3) is performed, data of all frequency bands is synthesized by a synthetic filter (step S4) and the synthesized data is outputted as PCM sound source data PSD.

In decoding (decompressing) audio data encoded (compressed) in compliance with the MPEG1 audio standard, decoded data of frequency bands is unbalanced such that the data exists only in specific frequency bands (low frequency side) and data of frequency bands having a logical “0” in all bits occurs relatively frequently. In an audio data reproducing system, when data extracted from a received bit stream is decoded (decompressed), repeatedly, it is temporarily stored in RAM before being read for various computations, and computation results are again stored in the RAM.

However, in conventional systems that reproduce compressed audio data, even data of frequency bands having a logical “0” in all bits has been written to RAM and read during decompression processing. The inventor et al. found that such a processing method had required unreasonably high power consumption attributed to access to the RAM. Particularly, since the MPEG1 audio standard is often adopted for portable electronic equipment operating on a battery such as MP3 players, reduction in power consumption is strongly desired.

### SUMMARY OF INVENTION

An object of the present invention is to offer a technique for decompressing compressed data so that systems which decompress data compressed in compliance with the MPEG or JPEG standard can reduce the number of accesses to RAM and system power consumption.

Another object of the present invention is to offer a technique for decompressing compressed data so that systems which decompress data compressed in compliance with the MPEG or JPEG standard can simplify computation processing for decoded data to reduce loads on the system, and increase computation processing speeds.

These and other objects, and novel characteristics of the present invention will become apparent from this specification and the accompanying drawings.

A brief description will be made be low of typical inventions disclosed in this application.

That is, in a digital data decompressing system that decompresses compressed digital data to restore original data thereof, it comprises plural memory areas in which the decompressed data is stored, and flags, provided so as to correspond one for one with the plural memory areas, which indicate whether stored data is all predetermined logical values (e.g., “0”), wherein, when data to be written to the memory areas is all predetermined logical values, the corresponding flags are set to a first state.

More specifically, in a system that decompresses data compressed in compliance with the MPEG or JPEG standard, a buffer memory is split to plural banks to store values computed to decompress the compressed data; each of the banks is provided with an all-zero flag indicating whether all data in the bank is logical “0”s; when data to be written to a bank is all logical “0” (hereinafter simply described as “0”), a corresponding all-zero flag is set without performing actual writing to the buffer memory; and when data is read, the flag is checked, and when data within the bank is all “0”, reading from the buffer memory is omitted.

According to the above means, when data to be stored in a bank as a memory area is all “0”s or data to be read from the bank is all “0”s, since access to the buffer memory is not made, the number of memory access decreases and power consumption is reduced. Moreover, even though writing to or reading from the buffer memory is not performed, by checking the all-zero flags during decompression, it can be determined whether data is all “0”s.

An arithmetic circuit for performing computations between data items stored in the memory areas is provided, wherein, when two data items stored in the memory areas are to be added, if the flag corresponding to one of the two data items to be added is set to the first state, data in another memory area whose flag is not set to the first state is read and stored in a third memory area in which data after the computations is to be stored.

More specifically, when data in a bank and data in another bank are to be added, all-zero flags are checked, and when it is determined that data of one of the banks is all “0”s, data of the bank whose data is not “0” is read and copied to a bank in which computation results are to be stored, and an all-zero flag corresponding to the bank is set. Thereby, when data of a bank whose data is all “0”s and data of another bank are added, since data reading from one of the banks and computations by the arithmetic circuit can be bypassed, computation processing and the number of memory accesses decrease and power consumption is reduced, and computation time in decompression processing is shortened.

The arithmetic circuit for performing computations between data items stored in the memory areas is provided, wherein, when two data items stored in the memory areas are to be multiplied, if the flag corresponding to one of the two data items to be multiplied is set to the first state, the flag corresponding to a memory area in which data after the computations is to be stored is set to the first state.

More specifically, when the product of data in a bank and data in another bank is to be computed, all-zero flags are checked, and when it is determined that data of one of the banks is all “0”s, writing to a bank in which computation results are to be stored is bypassed and a corresponding all-zero flag is set. Thereby, when the product of data of a bank whose data is all “0”s and data of another bank is computed, since access to the buffer memory and computations can be bypassed, computation processing and the number of memory accesses decreases and power consumption is reduced, and computation time in decompression processing is shortened.

Further, the digital data decompressing system includes the arithmetic circuit for performing computations between data items stored in the memory areas, and a memory management unit for managing information for identifying plural memory areas in which the above data is stored, wherein, when two data items stored in the memory areas are to be added, if the flag corresponding to one of the two data items to be added is set to the first state, identification information of a memory area with the flag set to a second state and identification information of a memory area in which data after computations is to be stored are interchanged, and the flag corresponding to a memory area in which data after computations has been stored as a result of the interchange is set to the second state.

More specifically, a bank number is assigned to each bank, when data in a bank and data in another bank are to be added, all-zero flags are checked, and when it is determined that data of one of the banks is all “0”s, writing to a bank in which computation results are to be stored is omitted, the bank numbers of the bank in which computation results are to be stored, and a bank whose data is not all zeros are interchanged, and an all-zero flag corresponding to the bank in which computation results are to be stored is reset. Thereby, when data in a bank and data in another bank are to be added, since the same effect is obtained without actually performing computations, computation processing and the number of memory accesses decrease and power consumption is reduced, and computation time in decompression processing is shortened.

Furthermore, there is provided a fixed data output unit that, when data is to be read from a bank with an all-zero flag set, outputs data of logical “0” instead of the data of the bank. Thereby, in computation using bank data, where “0” data of a bank with an all-zero flag set is required, since alternative data can be obtained from the fixed data output unit without performing bank writing and reading, correct computation results can be easily obtained.

### BRIEF DESCRIPTION OF THE DRAWINGS

FIG. 1 is a block diagram showing an embodiment of an audio data reproducing system to which the present invention is applied and which decompresses audio data in compliance with the MPEG1 audio standard to reproduce sounds;

FIG. 2 is a flowchart showing a procedure for creating PCM data from a bit stream in a decoding part of the embodiment of FIG. 1;

FIG. 3 is a block diagram showing in more detail the decoding part of the audio data reproducing system of FIG. 1;

FIGS. 4A and 4B illustrate an example of data writing to a bank memory in a decompressing system having no all-zero flags;

FIGS. 5A and 5B illustrate an example of data writing to a bank memory in a decompressing system of an embodiment having all-zero flags;

FIGS. 6A and 6B illustrate how all-zero flags and data stored in a bank memory change after execution of multiplications in a decompressing system of an embodiment having the all-zero flags;

FIGS. 7A and 7B illustrate how all-zero flags and data stored in a bank memory change after execution of additions in a decompressing system of an embodiment having the all-zero flags;

FIGS. 8A and 8B illustrate how all-zero flags, bank numbers, and data stored in a bank memory after execution of additions in a decompressing system of an embodiment having the all-zero flags and a bank number management unit;

FIG. 9 is a block diagram showing an embodiment (bank number fixed system) of a decompressing system having all-zero flags and a bank number management unit;

FIG. 10 is a block diagram showing another embodiment (bank number changeable system) of a decompressing system having all-zero flags and a bank number management unit;

FIG. 11 is a flowchart showing a procedure for decoding audio data in a decoding part of a decompressing system of an embodiment including bank management by a bank management unit;

FIG. 12 illustrates an outline of a procedure for compressing (encoding) and decompressing (decoding) image data in compliance with JPEG;

FIGS. 13A and 13B illustrate an example of DCT coefficients of sample data produced by performing Huffman decoding for data compressed in compliance with the JPEG standard, and the order of encoding frequency components subjected to DCT conversion in compliance with the JPEG standard;

FIG. 14 is a block diagram showing an embodiment in the case where the present invention is applied to an image data reproducing system that decompresses image data compressed in compliance with the JPEG standard;

FIG. 15 illustrates how to split data stored in a bank memory in the decompressing system of the embodiment of FIG. 14;

FIG. 16 illustrates a detailed data processing procedure in a decompressing system of JPEG method; and

FIG. 17 is a flowchart showing an outline of a decoding procedure for decompressing audio data compressed in compliance with layer III of MPEG1.

### DESCRIPTION OF THE PREFERRED EMBODIMENTS

Hereinafter, preferred embodiments of the present invention will be described using the accompanying drawings.

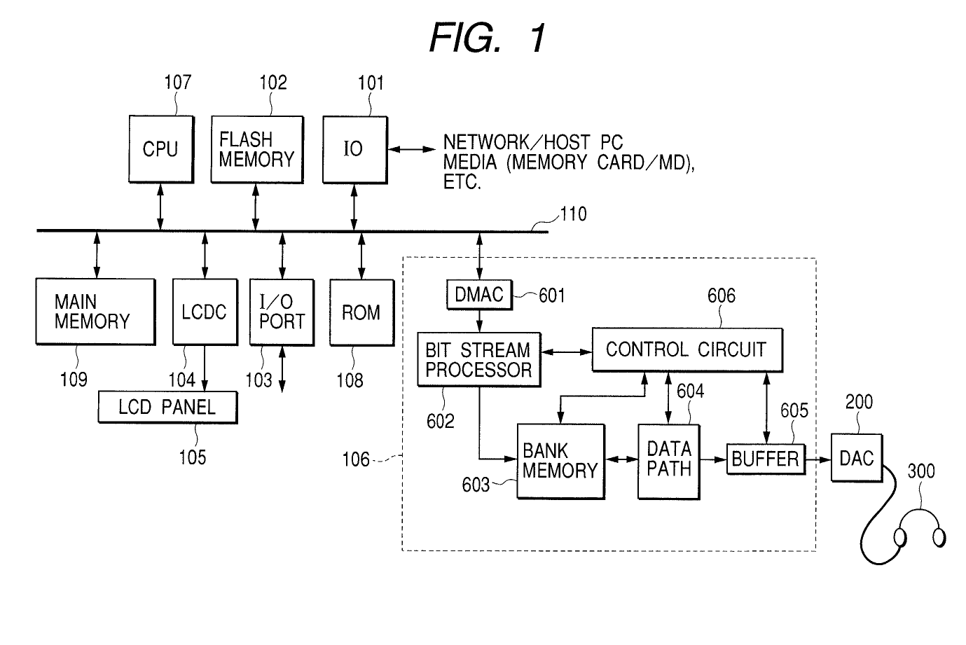

FIG. 1 is a block diagram of an audio data reproducing system, e.g., an MP3 player, that decompresses audio data in compliance with the MPEG1 audio standard to reproduce sounds. A reference numeral 101 designates an input-output circuit that gets a bit stream of compressed data received from a transmission medium such as a network or read from a storage medium such as a memory card; 102, a flash memory for storing the got bit stream; 103, an input-output port for getting signals from operation buttons and the like; 104, a liquid crystal controller for controlling a display unit 105 such as a liquid crystal panel; 106, a decoding part for decompressing the bit stream stored in the flash memory 102; 107, a central processing unit (CPU) for controlling the overall system according to programs; 108, a read-only memory (ROM) for storing programs to be executed by the CPU 107 and permanent data; and 109, a random access memory (RAM) for providing a working area of the CPU 106, which are connected with each other through a system bus 110.

Further, the decoding part 106 comprises: a DMA (direct memory access) controller 601 for getting data from the flash memory 102 by DMA transfer; a bit stream processor 602 for analyzing the format of a got bit stream and decoding compressed data; a bank memory 603 comprising RAM in which decoded data and data subjected to computation processing are stored; a data operation unit 604, comprising multiplier, adder, and barrel shifter, for performing dequantization and other computations; a buffer 605 for storing PCM data outputted after termination of decoding (decompressing); and a control circuit 606 for controlling the overall decoder 600 and performing frequency to time space conversion and other computations. Decoded audio data stored in the buffer 605 is supplied to a DA converter 200, where it is converted to an analog signal before being reproduced by a sound output unit 300 such as headphones, earphones, or loudspeaker. The function of the bit stream processor 602 can also be implemented by software, in which case the control circuit 606 substitutionally performs that function.

In the audio data reproducing system of FIG. 1, a bit stream (compressed data) received from transmission media such as networks or read from storage media such as memory cards is inputted to the input-output circuit 101 and temporarily stored in the flash memory 102. The bit stream stored in the flash memory 102 is transferred to the bit stream processor 602 by DMA by the DMA controller 601 within the decoding part 106, and its format is analyzed by the bit stream processor 602 and the bit stream is decoded and stored in the bank memory 603.

The data stored in the bank memory 603 is subjected to dequantization, butterfly computation (Fourier transform), inverse MDCT computation, and other processing cooperatively by the data operation unit 604 and the control circuit 606, is stored in the buffer 605 as PCM sound source data, is outputted to the DA converter 200 from the buffer 605, is subjected to DA conversion according to a sampling frequency such as, e.g., 44.1 kHz by the DA converter 200, and is reproduced by the sound output unit 300. The results of dequantization, butterfly computation, inverse MDCT computation, and other processing, except for a last computation, are stored in the bank memory 603 again, and the results of the last computation are stored in the buffer 605.

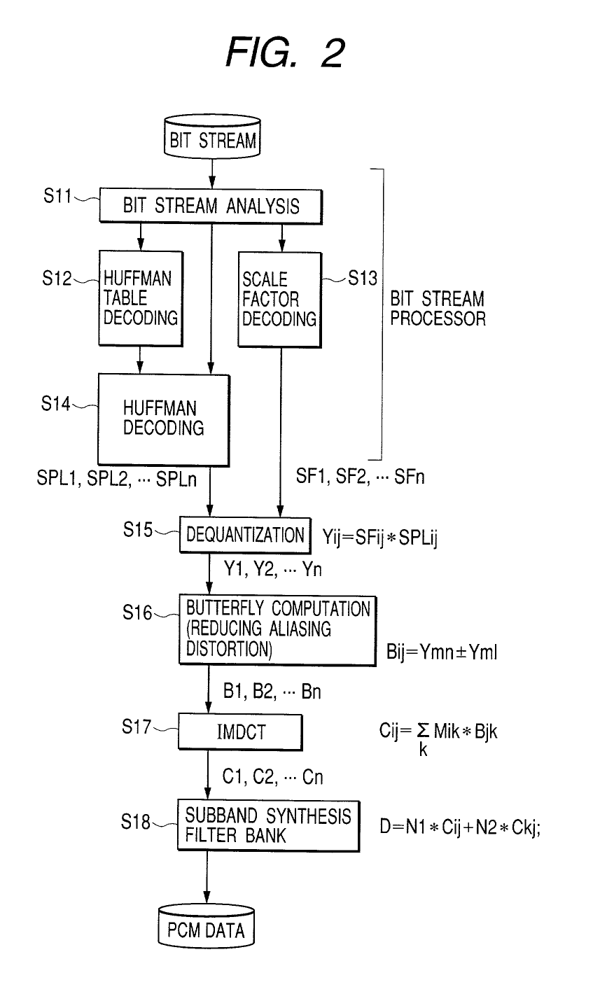

A procedure for creating PCM data from a bit stream in the decoding part 106 will be described in detail with reference to FIG. 2.

A bit stream transferred from the flash memory is analyzed as to its format on a frame basis (step S11). According to the format, a code table (Huffman table) of Huffman codes in the bit stream and a dequantization table corresponding to a quantization scale having been used in quantization are extracted and decoded (steps S12 and S13). Next, variable-length subband sample data contained in the bit stream is extracted and is decoded using the Huffman code table obtained in the step S12, and fixed-length sample data SPL1, SPL2, . . . , SPL32 (=SPLij) of mutually different frequency bands are obtained (step S14). The processing up to this point is performed by the bit stream processor 602 in the system of FIG. 1, and the obtained Huffman code table, the dequantization table, and the sample data are stored in the bank memory 603.

Next, the sample data decoded in step S14 is dequantized using the dequantization tables obtained in step S13, that is, the sample data SPLij and dequantization coefficients SFij are multiplied, and computation results Y1, Y2, . . . , Yn (=Ymn) are stored in the bank memory 603 (step S15). Computation called butterfly computation for reducing aliasing distortion, that is, data addition or subtraction Bij=Ymn±Yml within an identical bank is performed according to a predetermined procedure, and computation results B1, B2, . . . , Bn (=Bij) are stored in the bank memory 603 (step S16). Inverse modified discrete cosine transform (IMDCT) is performed (step S17).

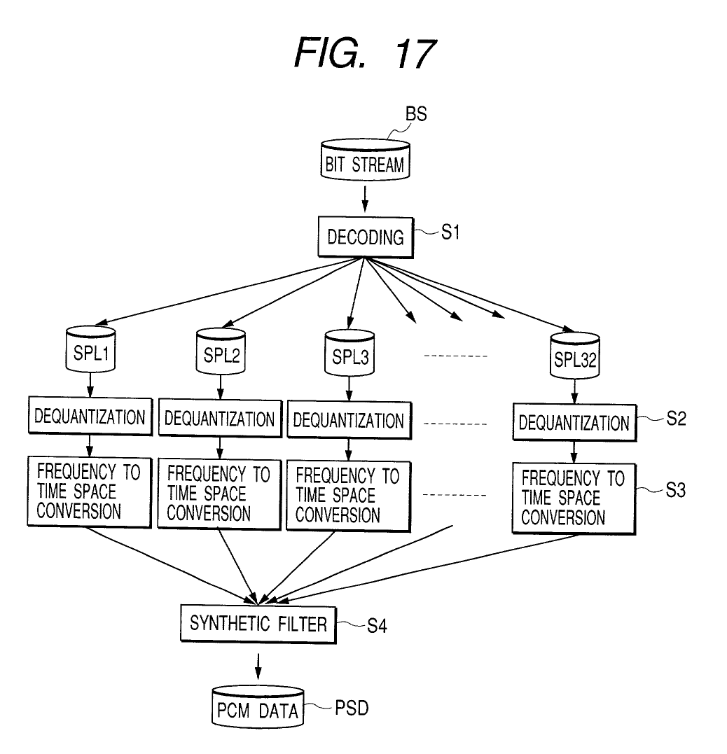

The IMDCT transform consists of multiply and accumulate computations Cij=ΣMij*Bik between the butterfly computation results Bjk of step S16 and IMDCT coefficients Mik. Computation results C1, C2, . . . , Cn (=Cij) are stored in the bank memory 603. The IMDCT coefficients may be stored beforehand in the bank memory 603 or transmitted contained in the bit stream. The butterfly computation of the step S16 and the IMDCT transform of step S17 are processing corresponding to inverse conversion of the frequency to time space conversion in FIG. 17.

After termination of the IMDCT transform, the decoded and decompressed sample data Cij of the above frequency bands are respectively multiplied by weight coefficients, and the results are added so that the subband data is synthesized (D=N1*Cij+N2*Ckj) to restore one block (8 ms) of the original data (step S18). The synthesized data is successively stored in the buffer 605 as PCM sound source data. The above computations are an example; depending on the types and attributes of data to be decoded, computations may be partially omitted, replaced by other computations, or added with different computations, and the present invention can apply to such cases also.

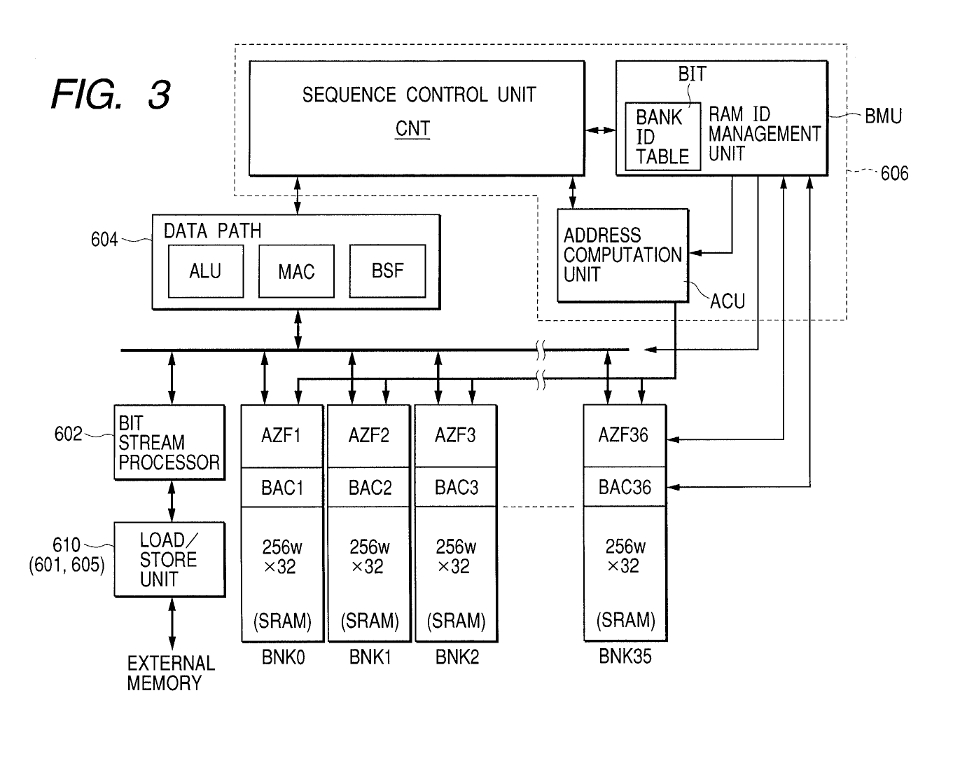

FIG. 3 is a drawing showing an embodiment of the present invention and shows in more detail a part of the decoding part 106 in the audio reproducing system of FIG. 1; a system described in this embodiment is substantially identical with the system of FIG. 1. Circuit blocks in FIG. 3 that are identical to those in FIG. 1 are identified by the same reference numerals, and duplicate descriptions will be omitted. In FIG. 3, a load/store unit 610 is depicted as one block to show the functions of the DMA controller 601 and the buffer 605 in FIG. 1, and has the same functions as them. The bit stream processor 602 is shown by a dashed line to indicate that the function of the processor can also be implemented by the control circuit 606.

The control circuit 606 comprises: a sequence control unit CNT comprising a micro ROM storing, e.g., microinstructions, an instruction decoder for decoding the microinstructions to create control signals, and a sequencer for controlling the order of instructions to be executed; a bank management unit BMU having a bank ID table BIT storing bank numbers of the bank memory 603 to manage the bank numbers; and an address computation unit ACU for computing addresses for accessing banks of the bank memory 603. The data operation unit 604 comprises an arithmetic and logical unit ALU for performing logical operations, a multiple and accumulate unit MAC for multiple and accumulate operations, and a barrel shifter BSF for performing data bit shift and other operations.

In this embodiment, the bank memory 603 comprises, e.g., 36 banks BNK0, BNK1, . . . , and BNK35. Each bank BNKi (i=0, 1, . . . , 35) is configured so as to have a storage capacity of, e.g., 256×32 bits capable of holding 256 pieces of sample data consisting of one block, and is provided with a bank activating circuit BACi for placing the bank into a selection state when a bank number assigned to the bank is inputted, and an all-zero flag AZFi for declaring that the bank contains all-zeros regardless of actual data within the bank. Sample data and coefficients computed in the process of the decoding and decompression processing described previously are respectively stored in different banks, and after being computed in the data operation unit 604, are stored in the original banks or further other banks.

In FIG. 3, ADB is an address bus for supplying an address created in the address computation unit ACU to the banks BNK0 to BNK35 of the bank memory 603, and DTB is a data bus for enabling data transfer between the load/store unit 610, the bank memory 603, and the data operation unit 604.

Major points of the present invention are that each bank has an all-zero flag AZFi and how the all-zero flag AZFi is used. In DCT transform used to compress image data or audio data in compliance with the JPEG standard or MPEG standard, specific frequency components tend to appear in large quantity because of unbalanced frequency distribution of input data after the DCT transform. Therefore, when the input data are quantized taking advantage of this property, a large number of frequency components of “0” are produced, so that a high compression ratio is obtained. Unsparingly writing data containing a large number of frequency components of “0” to the bank memory would wastefully make the ratio of time required for writing of “0” to memory access time very high. The present invention provides each bank of the bank memory with an all-zero flag AZFi to avoid such writing and reading of “0” to and from the bank memory.

Hereinafter, a description will be made of bank control and data decoding and decompression by use of the all-zero flag AZFi.

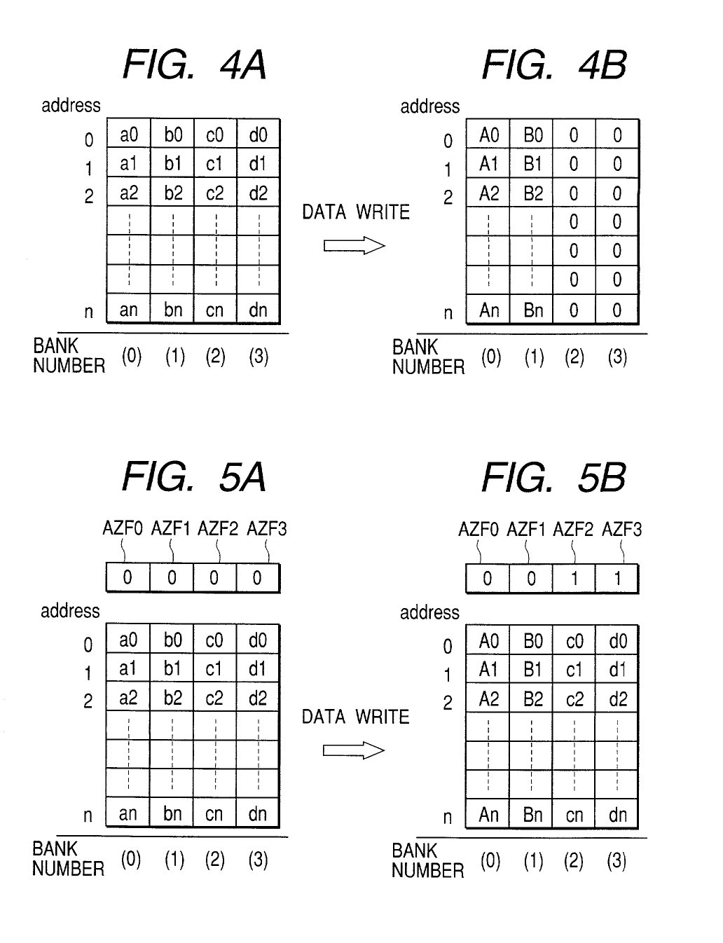

Suppose data of four frequency bands {A0, A1, . . . , An}, {B0, B1, . . . , Bn}, {C0, C1, . . . , Cn}, and {D0, D1, . . . , Dn} is inputted through a bit stream and is written to four banks BNK0, BNK1, BNK2, and BNK3. In a system in which a bank memory is not provided with all-zero flags AZFi, even if C0 to Cn and D0 to Dn are all “0”s, data of the frequency bands will be written to all banks of the bank memory regardless of whether the data is “0” or not, as shown in FIGS. 4A and 4B. In the drawing, A0, A1, . . . , An, B0, B1, . . . , Bn are data having a bit length of 32 bits each, and n is, e.g. 256.

On the other hand, in the embodiment of the present invention, where four pieces of data as described above are to be written to banks BNK0, BNK1, BNK2, and BNK3, although data {A0, A1, . . . , An} and {B0, B1, . . . , Bn} are written to the banks BNK0 and BNK1, as shown in FIGS. 5A and 5B, no data is written to the banks BNK2 and BNK3 to leave the original data {c0, c1, . . . , cn}, {d0, d1, . . . , dn} intact, and corresponding all-zero flags AZF2 and AZF3 are set to “1” to declare that data to be written are all “0”s. Where data is to be read from the banks, the status of all-zero flags AZFi is sensed, and if it is “1”, data will not be read from the banks.

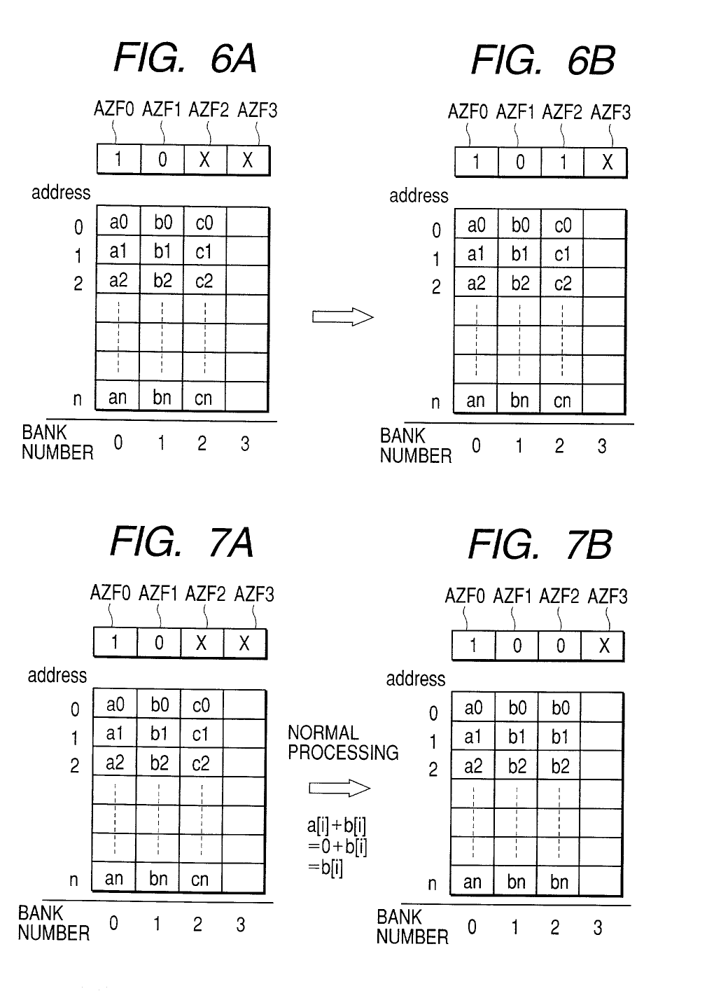

Next, a description will be made of a method of concrete computations between data items stored in banks in a system in which the banks each are provided with an all-zero flag AZFi, as in the embodiment of the present invention. For example, as shown in FIG. 6A, suppose data of all zeros of bank BNK0 whose all-zero flag AZF is 1 and significant data of bank BNK1 whose all-zero flag AZF is 0 are multiplied and the results are stored in bank BNK2. The multiplication of data of bank BNK0 and data of bank BNK1 denotes that i-th (i=0 to n) data ai of bank BNK0 and i-th data bi of bank BNK1 are successively multiplied in the range of i from 0 to n.

In this case, in the system of this embodiment, actual multiplications of data are not performed, and as shown in FIG. 6B, all-zero flag AZF2 of bank BNK2 is set to “1” and processing terminates. In this way, if the all-zero flag AZF is used, in multiplications of data items in two different banks, when either of them contains data of all zeros, data reading and writing from and to the banks does not need to be performed. In FIGS. 6A and 6B, “X” in the all-zero flag AZF indicates “0” or “1”.

Next, for example, as shown in FIG. 7A, suppose data of all zeros of bank BNK0 whose all-zero flag AZF is 1 and significant data of bank BNK1 whose all-zero flag AZF is 0 are added and the results are stored in bank BNK2. The addition of data of bank BNK0 and data of bank BNK1 denotes that i-th (i=0 to n) data ai of bank BNK0 and i-th data bi of bank BNK1 are successively added in the range of i from 0 to n.

For additions in the case where the all-zero flag is not provided, it is necessary to read data of the bank BNK0 as well as data of the bank BNK1, add the respective data, and write the results to the bank BNK2. On the other hand, in the system of this embodiment, actual additions of data are not performed, as shown in FIG. 7B, data of the bank BNK1 is copied to the bank BNK2, that is, data is read from the bank BNK1 and written to the bank BNK2, and the all-zero flag AZF2 of BNK2 is reset to “0” and processing terminates. In this way, if the all-zero flag AZF is used, in additions of data items in two different banks, when either of them contains data of all zeros, only data reading from one bank and writing to another bank are performed, so that actual computations can be omitted.

Moreover, in the above case, where added data is stored back in BNK1, not in BNK2, reading and writing from and to the banks does not need to be performed. Likewise, where data items of banks whose all-zero flag AZF is “1” are added, no actual additions are not performed and “1”s has only to be set in an all-zero flag AZF provided for a bank in which addition results are to be put.

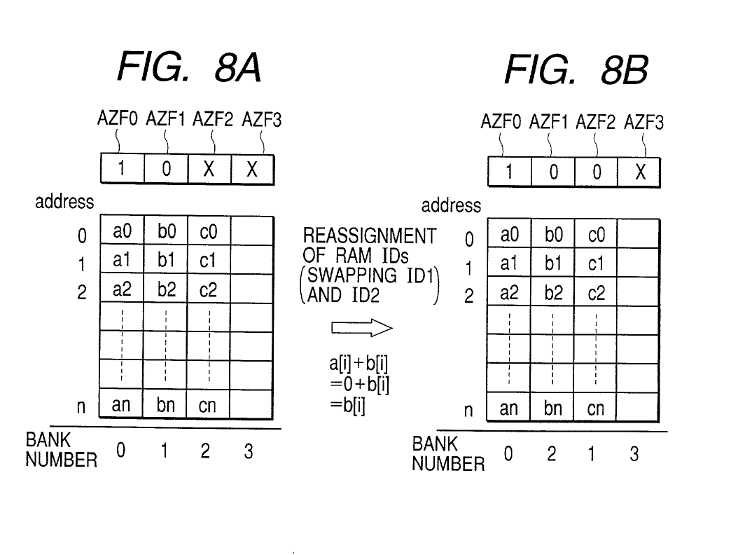

In a system which has a configuration similar to the system of FIG. 3 and in which bank numbers assigned to the banks BNK0 to BNK35 are not fixed and can be arbitrarily reassigned by the bank management unit BMU, where data of all zeros of the BNK0 whose all-zero flag is “1” and significant data of the bank BNK1 whose all-zero flag AZF is “0” are added and the results of the additions are stored in the bank BNK2, the bank numbers of the banks BNK1 and BNK2 can be reassigned as shown in FIGS. 8A and 8B, and the all-zero flag of a new bank BNK1 (original bank BNK2) can be reset to “0”. In this way, where bank numbers can be reassigned and one of the banks contains data of all zeros, bank reading and writing, and computations do not need to be performed, except that reassignment of the bank numbers and resetting of the all-zero flag AZF are performed.

In the above case, although a new bank BNK1 (third column) to which a new number is assigned has its associated all-zero flag set to “0” though stored with insignificant data, since the bank management unit BMU can recognize that the data is insignificant, there is no problem. If bank management in the bank management unit BMU is sufficiently made, resetting the all-zero flag AZF of the new bank BNK1 (original bank BNK2) to “0” can be omitted during the reassignment of the bank numbers. Specifically, for each of the banks, in addition to the all-zero flag AZF, e.g., a flag indicating whether data within a bank is valid or invalid may be provided and managed by the bank management unit BMU.

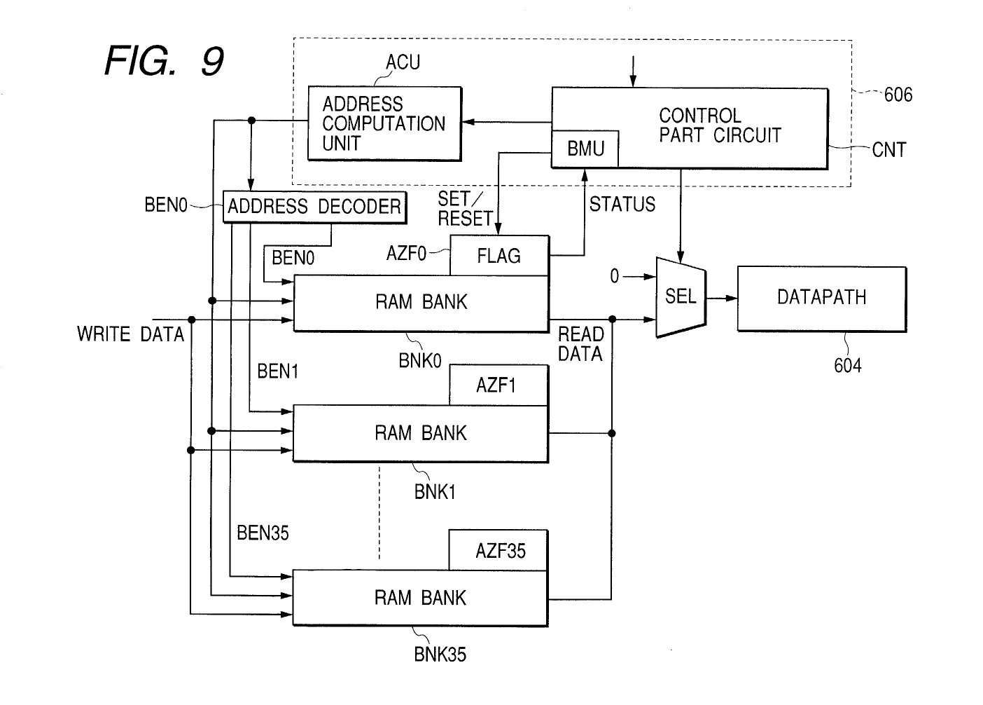

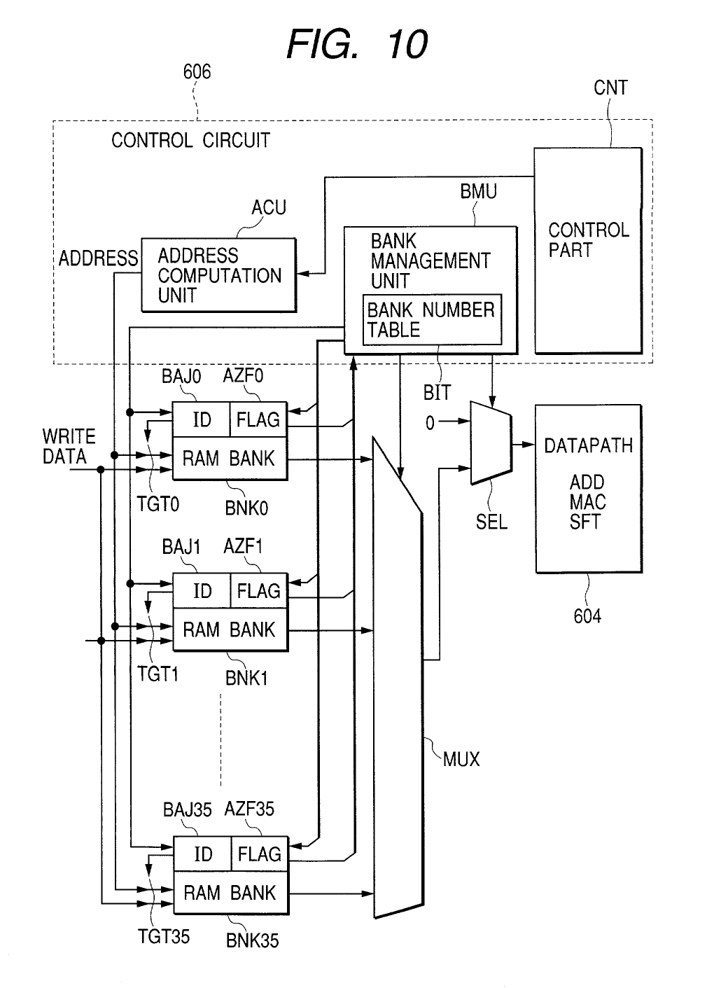

Next, an example of a specific system configuration capable of the above bank control by use of all-zero flags will be described using FIGS. 9 and 10. FIG. 9 shows an example of a system in which bank numbers are fixed, and FIG. 10 shows an example of a system in which bank numbers are changeable.

In the system of FIG. 9 in which bank numbers are fixed, a bank number decoder BND is provided which decodes high-order six bits of an address corresponding to a bank number of an address outputted from, e.g., the address computation unit ACU, creates enable signals BEN0 to BEN35 for specifying a target bank, and supplies them to the banks BNK0 to BNK35. A selector SEL is provided at the output side of the banks BNK0 to BNK35; the data output terminals of the banks are connected in common to one of input terminals of the selector SEL, and fixed data “0” is inputted to another input terminal.

In the system of this embodiment, an address outputted from the address computation unit ACU is supplied in common to the banks BNK0 to BNK35, and only a bank with a corresponding enable signal BEN asserted is activated to read or write data at an address specified by low-order eight bits of the address.

In this system, the bank management unit BMU has a function to manage all-zero flags of the banks, thereby omitting writing data of all zeros to a bank by setting a corresponding flag AZF to “1” during data writing, adding, or multiplication, as described previously. During data reading, the bank management unit BMU checks the all-zero flag AZF of a target bank and does not perform data reading from the bank when the flag is “1”, and switches the selector SEL provided at the output side of the bank to the fixed data “0” side. Thereby, during synthesizing of subband sample data after termination of decoding, when data is to be read from a bank with a corresponding all-zero flag AZF set to “1”, the fixed data “0” is outputted from the selector SEL instead of the bank data so that correct decoded data is read and computation is performed using the data.

In the system of FIG. 10, the bank management unit BMU is provided with a bank ID table BIT for managing bank numbers. The banks BNK0 to BNK35 are respectively provided with bank access judging circuits BAJ0 to BAJ35 that comprise an all-zero flag AZF0 to AZF35, a register for holding its own bank number, and a comparator for comparing a bank number held in the register and a bank number of high-order bits of an address supplied from the address computation unit ACU.

Gate units TGT0 to TGT35 that can pass and block an input address and input data are provided at the input side of the banks, and the Gate unit TGT0 to TGT35 are controlled so as to go to a passage state by a signal from the bank access judging circuits BAJ0 to BAJ35 when a bank address of, e.g., high-order six bits of an address outputted from the address computation unit ACU matches a bank number in a bank number register within the bank access judging circuits BAJ0 to BAJ35.

At the output side of the banks are provided a multiplexer MUX that can selectively transmit one of outputs of the banks BNK0 to BNK35 to a following stage, and the selector SEL that can output the fixed data “0” instead of bank output data. The selector SEL is switched according to the all-zero flags AZF0 to AZF35 of the banks BNK0 to BNK35 that are checked by the bank management unit BMU during reading of bank data as in the previous embodiment. The multiplexer MUX is also controlled by the bank management unit BMU consulting the bank ID table BIT so that data of a desired bank is outputted.

In the system of this embodiment, the bank management unit BMU can updates the bank ID table BIT and bank number registers within the bank access judging circuits BAJ0 to BAJ35. Thereby, by reassigning bank numbers and setting the all-zero flags AZF as described using FIGS. 8A and 8B, the same effect as adding data of a bank whose all-zero flag AZF is “1” and data of a bank whose all-zero flag AZF is “0” can be obtained without performing data reading from the banks, computations, and writing to the banks.

Although, in the system of FIG. 10, the bank access judging circuits BAJ0 to BAJ35 are provided to reassign bank numbers by hardware, the bank numbers can also be reassigned by software in the bank management unit BMU or the sequence control unit CNT. Instead of providing the bank access judging circuits BAJ0 to BAJ35 each having a register to be loaded with a bank number, the banks may be respectively provided with a decoder for decoding a bank number outputted from the bank management unit BMU so that the bank management unit BMU outputs a bank number for specifying a desired bank by consulting the bank ID table BIT.

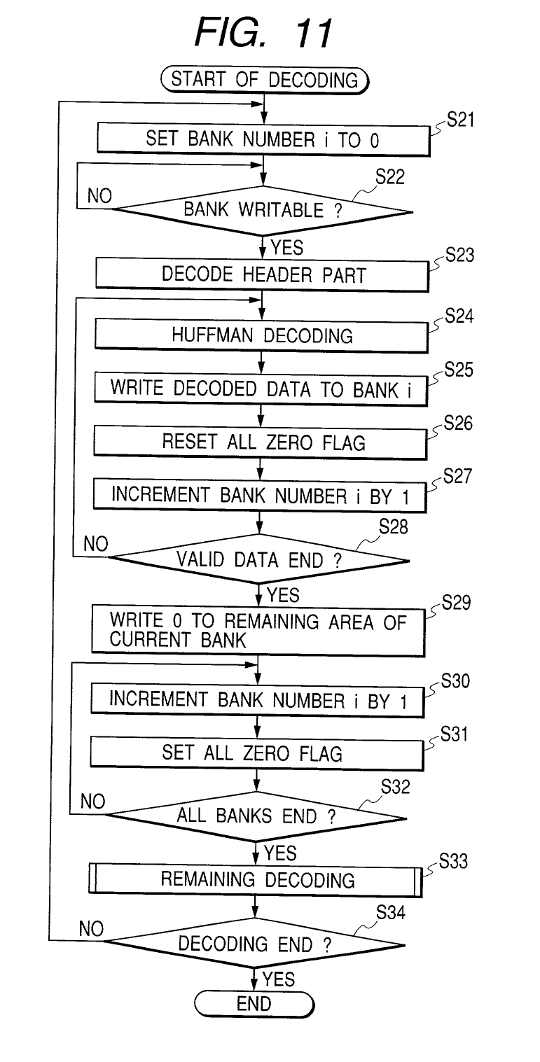

Next, referring to FIG. 11, a description will be made of a procedure for decoding audio data in the decoding part 106, along with bank management by the bank management unit BMU.

The decoding part 106 starts decoding processing by setting a variable indicating a bank number to “0” (step S21). It judges whether to start writing to a bank of bank number i (step S22). Specifically, the judgment can be made by seeing, e.g., a flag indicating control status and a status register within the control circuit 606 to judge whether decoding of a next frame may be started after a previous frame has been decoded. If it is judged that writing can be started, control proceeds to the next step S23, where a header part is decoded by the bit stream processor 602 to obtain the number of data items within the frame.

Next, sample data is extracted from a bit stream to perform Huffman decoding (step S24). The decoded sample data of each frequency band is stored in a bank of bank number i (=0) set by step S21, and an all-zero flag AZFi corresponding to the bank is reset to “0” (steps S25 and S26). If the decoded sample data reaches the capacity of the bank, the bank number i is incremented (i→1) (step S27).

Thereafter, it is judged whether all valid data (data other than “0”) within the frame has been decoded (step S28). The judgment of the number of valid data items can be made by determining whether the number of data items of valid data count information within the bit stream matches the number of decoded data items. When it is judged that not all valid data has been decoded, control returns to step S24 to decode the next sample data, and if it is judged that all valid data has been decoded, in the next step S29, all data “0”s are written to a remaining area of a current bank.

Thereafter, the bank number is incremented (i←i+1) and the all-zero flag of a corresponding bank is set to “1” (steps S30 and S31). Because of the nature of audio data compression complying with the MPEG1 standard, the compressed audio data has the characteristics that sample data of different frequency bands is unbalanced such that, if “0” appears in the sample data, remaining sample data is all “0”s. For this reason, writing of “0” to the next bank is omitted by setting the all-zero flag AZFi to “1” instead of writing sample data of “0” to the bank.

It is judged whether data writing (including the setting of all-zero flags AZFi) to all banks terminates (step S32). If it does not terminate, control returns to step S30 to repeat the above processing, and when it is judged in step S32 that it terminates, remaining decoding processing (butterfly computation processing, inverse MDCT conversion processing, and subband synthesis processing) S33 is performed. It is judged in step S34 whether decoding for all frames terminates, and when it does not terminate, control returns to step S21 to repeat the above processing.

Next, a description will be made of an embodiment in which the present invention is applied to an image data reproducing system decompressing image data compressed in compliance with the JPEG standard.

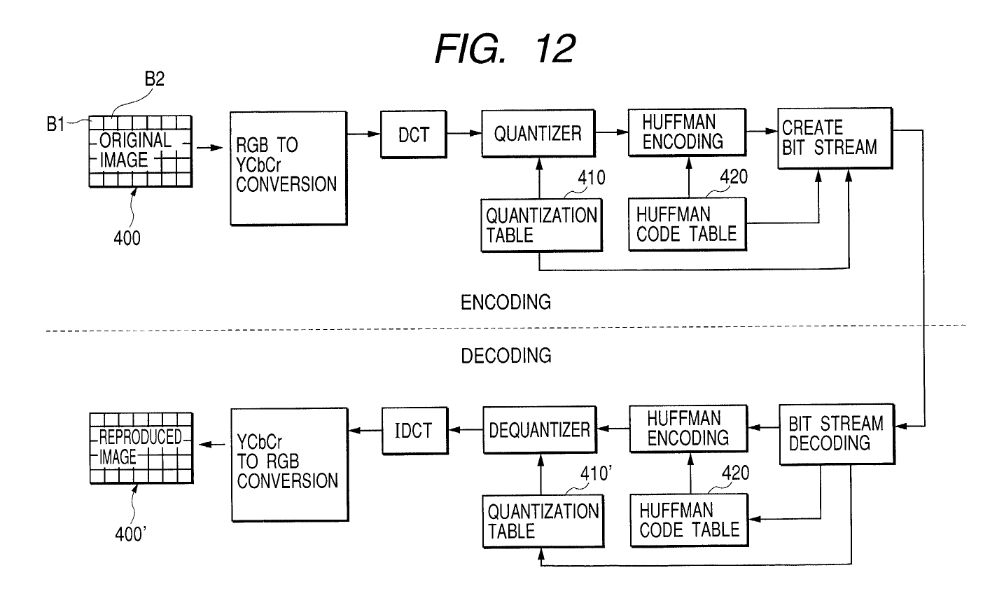

First, referring to FIG. 12, a description will be made of a procedure for compressing (encoding) and decompressing (decoding) image data in compliance with JPEG. In compression of the JPEG standard, a digital original image 400 to be compressed is split to blocks B1, B2, . . . of 8×8 pixels each, and for each block, sample data RGB of each of the three primary colors is converted to data of brightness Y and color difference components Cb and Cr. After two-dimensional DCT conversion (space to frequency conversion) is performed for the respective data of Y, Cb, and Cr, data compression by quantization (division and rounding off) is performed using a proper quantization table 410. Thereafter, Huffman encoding processing is performed using a Huffman code table 420 for further data compression.

Thereafter, the encoded sample data is added with a header, format information, error check code, bit allocation information, scale factor information, and other information to form a frame of a proper format. A bit stream in which frames each comprising a block are consecutive is created and sent to a decoding system.

A procedure for decoding image data is almost the same as that for decoding audio data as shown in FIG. 17, except that processing contents are somewhat different. That is, a bit stream is analyzed to extract sample data, Huffman decoding is performed using the code table 420, and dequantization (multiplication) is performed using a quantization table 410′. As the sample data, in the case of audio data, 8-ms data, used as one block, is split to 32 frequency bands and encoded, while, in the case of image data, data of 8×8 pixels, used as one block, is subjected to space to frequency conversion (RGB→YCbCr conversion and DCT conversion) and quantization for each color component before performing Huffman encoding. In decoding of image data, after the dequantization, inverse DCT conversion and YCbCr→RGB conversion corresponding to frequency to space conversion is performed before a reproduced image 400′ is created.

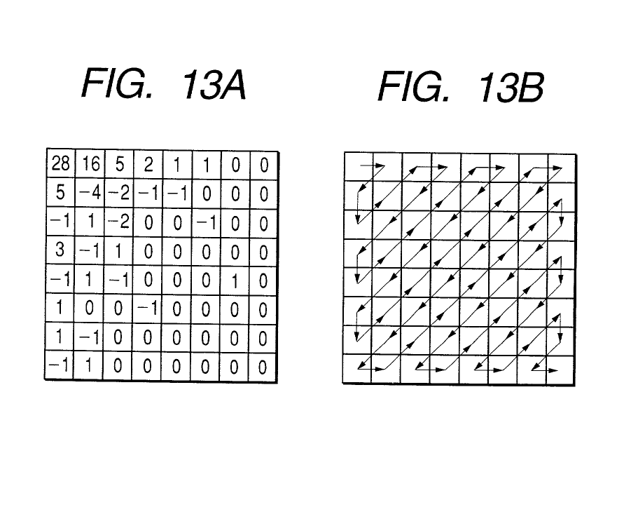

Like audio data, image data also has unbalanced frequency components in terms of spatial frequency and has the characteristics that normal image data is abundant in low-frequency components but scarce in high-frequency components. Therefore, in the case of sample data having been subjected to Huffman decoding, as shown in FIG. 13A, for example, valid data appears in low-frequency components at the upper left portion and has large values, but elements at the lower right portion are almost “0”. In the case of compression in compliance with the JPEG standard, 64 frequency components of each block are encoded in the order shown by the arrows in FIG. 13B and carried on a bit stream in that order.

In the image data reproducing system of this embodiment, to take advantage of the nature of image data, each of banks of a bank memory to store data of different frequency bands is provided with an all-zero flag so that writing of “0” to the banks and multiplication and other computations with “0” data during computation in decoding processing are replaced by setting or resetting of the all-zero flags, to thereby simplify processing.

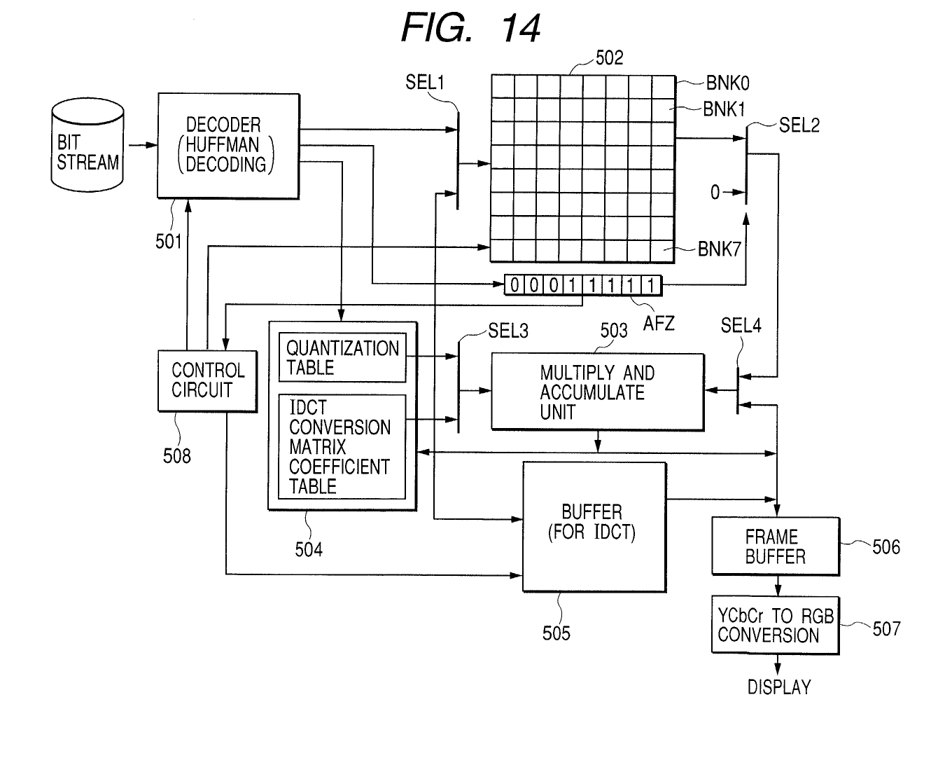

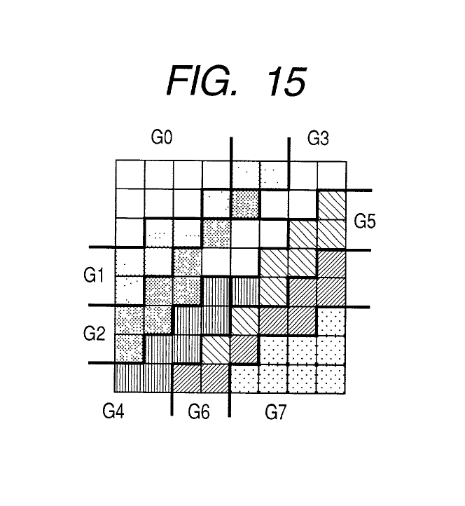

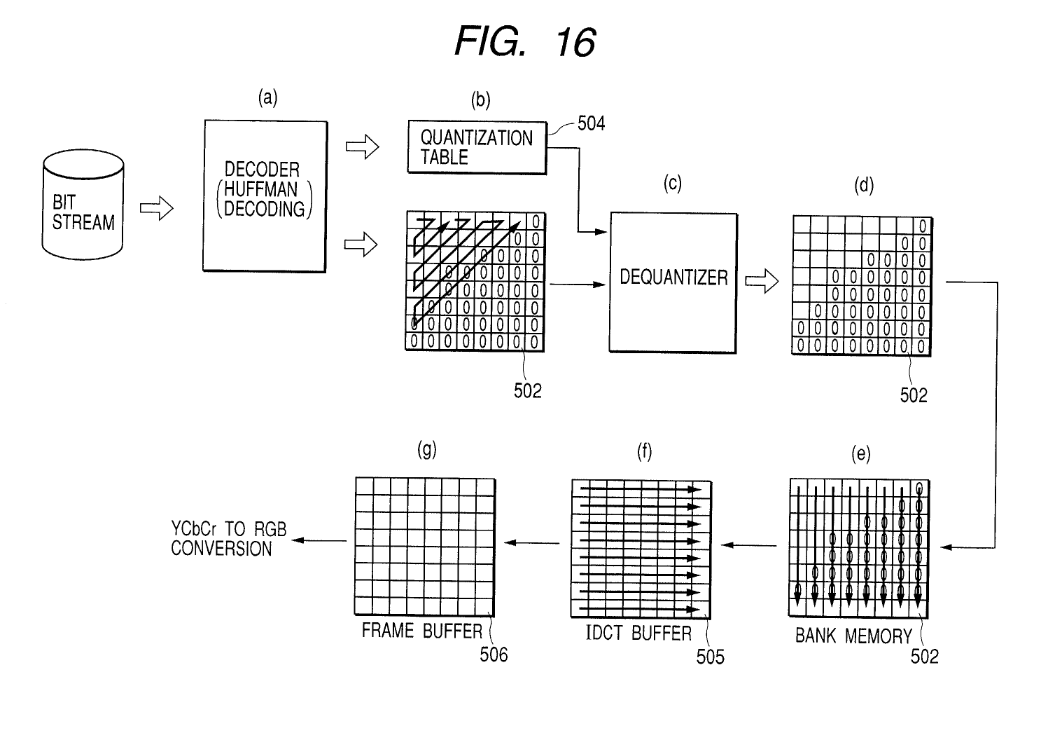

FIG. 14 show an embodiment of the present invention in the case where it is applied to an image data reproducing system that decompresses image data compressed according to the JPEG standard.

In FIG. 14, a reference numeral 501 designates a bit stream decoder that analyzes an inputted bit stream to perform Huffman decoding; 502, a bank memory comprising eight banks BNK0 to BNK7 each having an all-zero flag, wherein data of 64 (8×8) frequency bands are split to eight groups indicated by G0 to G7 as shown in FIG. 15 and stored in the banks; 503, an arithmetic circuit for performing multiply and accumulate operations; 504, a coefficient memory for storing a quantization table and a DCT coefficient table; 505, a buffer memory for holding one block of data used for inverse DCT conversion; 506, a frame buffer for holding data after inverse DCT conversion; 507, a conversion circuit for performing YCbCr to RGB conversion; and 508, a control circuit for controlling the overall system.

The coefficient memory 504 may also be provided as an independent bank within the same RAM in which the bank memory 502 exists. The same is also true for the inverse DCT conversion buffer 505. However, only the first eight banks BNK0 to BNK7 require the all-zero flag, and other banks, if any, require no all-zero flag.

SEL1 to SEL4 each are selectors for selecting data. Selector SEL2 has one input terminal to which data output terminals of the banks are connected in common, and another input terminal to which the fixed data “0” is inputted so that the selector is switched depending on the status of an all-zero flag AZF during data reading from the banks so as to output the fixed data “0” instead of the read data.

Next, specific decoding processing in the image data reproducing system of FIG. 14 will be described using FIG. 16. FIG. 16 graphically illustrates a flow of decoding processing in the image data reproducing system.

A bit stream inputted to the reproducing system is analyzed by the bit stream decoder 501, a quantization table extracted from the inputted bit stream is stored in the coefficient memory 505, and sample data of 64 frequency bands having been subjected to Huffman decoding is successively stored in the memory comprising eight banks BNK0 to BNK7. To be more specific, the sample data of the frequency bands is zigzaggedly stored as shown in the arrows of FIG. 16B. At this time, when data of a frequency band to be written to a bank memory is all “0”s, writing to the bank memory is bypassed and a corresponding all-zero flag is set to “1”.

Generally, a compression side does not send data “0” if it appears consecutively from a middle point to the end in the process of compression. Therefore, if data is embedded in the order of FIG. 16B, the number of decoded data items will not reach 64. In this case, a decoding system must fill remaining data with “0” and store it in the bank memory 502. In the system of this embodiment, however, no write is made to a bank memory and a corresponding all-zero flag is set to “1”. Since this reduces the number of actual accesses to the bank memory when sample data is stored in the memories, current consumption will be greatly reduced.

Next, sample data is read from the bank memory 502 and stored again in the bank memory 502 after being subjected to dequantization. At this time, the all-zero flags AZF are checked, and for data with the flag set to “0”, it is read to perform multiplication by values of the quantization table. For data with the flag set to “1”, data reading and multiplication are omitted and the all-zero flag is kept set to “1”. Dequantization is represented by an expression Yij=Xij×Cij, where Xij is sample data of i-th row and j-th column before dequantization and Cij is a value of the dequantization table. Accordingly, since data items of “0” remain “0” after dequantization, computations can be omitted as described above. This greatly reduces accesses to the bank memory and time required for computations during dequantization.

The next inverse DCT conversion is performed by matrix computations of two stages. At the first stage, as shown by the arrows in FIG. 16E, data Xj within the bank memory is read in the columnar direction; in the multiply and accumulate circuit 503 of FIG. 14, matrix computations Yj=ΣMij×Xj with IDCT coefficients Mij are successively performed in the range of j from 0 to 7, that is, from the first column to the eighth column; and computation results are stored in the buffer memory 505. This is performed for all data of the banks BNK0 to BNK7. At the next stage, as shown by the arrows in FIG. 16F, data Xi within the buffer memory is read in the row direction; matrix computations with IDCT coefficients Mij are successively performed in the range of i from 0 to 7, that is, from the first row to the eighth row; and computation results are stored in the frame memory 506 (FIG. 16G).

In the image data reproducing system of this embodiment, in the matrix computation of the first stage, all-zero flags are checked before reading data from the banks BNK0 to BNK7, and for data with “1” set, instead of reading the data from a corresponding bank, the selector SEL2 is switched so as to pass the fixed data “0” to the multiply and accumulate circuit 503. This omits access to the bank memory in the inverse DCT conversion, resulting in a significant reduction in current consumption. Also, since time required for output of the fixed data “0” from the selector is less than memory access time, total time required for computations is reduced.

Although the invention made by the inventor has been described in detail based on embodiments, it goes without saying that the present invention is not limited to the above embodiments and various modifications and improvements may be implemented without departing from the sprit of the invention. For example, although, in the embodiments, the set state of an all-zero flag AZF is associated with the state in which data of a corresponding bank is all “0”s, the reset state of an all-zero flag AZF may be associated with the state in which data of a corresponding bank is all “0”s.

In the audio data reproducing system (see FIGS. 9 and 10) of the embodiment, for each of the memory banks BNK0 to BNK35, an address decoder is provided. However, an address decoder of the bank memory 603 may be provided in common for the entire memory so that the memory is split to virtual banks by software processing of the bank management unit. The audio data in this specifications includes not only music data in a narrow sense but also sound data such as recitation.

Although the invention made by the inventor has been primarily described as to application to an audio data reproducing system conforming to the MPEG1 layer III standard and an image data reproducing system of the JPEG standard, the present invention can be used for general systems that decompress digital compressed data.

Typical effects obtained by the present invention are as described below.

According to the present invention, in a system that decompresses data compressed by a given compression method complying with the MPEG or JPEG standard, the number of accesses to RAM can be decreased to reduce the power consumption of the system, computation processing for decoded data can be simplified to reduce loads on the system, and computation processing speeds can be increased.

What is claimed is:

1. A digital data decompressing system that decompresses compressed digital data to restore original data thereof, comprising:
plural memory areas in which the decompressed data is stored; and
flags, provided so as to correspond one for one with the plural memory areas, which indicate whether stored data is all predetermined logical values,
wherein, when data to be written to the memory areas is all predetermined logical values, the corresponding flags are set to a first state.

2. The digital data decompressing system according to claim 1, wherein the predetermined logical value is a logical “0”.

3. The digital data decompressing system according to claim 2, including an arithmetic circuit for performing computations between data items stored in the memory areas, wherein, when two data items stored in the memory areas are to be added and the flag corresponding to one of the two data items to be added is set to the first state, data in another memory area whose flag is not set to the first state is read and stored in a third memory area in which data after the computations is to be stored.

4. The digital data decompressing system according to claim 2, including an arithmetic circuit for performing computations between data items stored in the memory areas, wherein, when two data items stored in the memory areas are to be multiplied and the flag corresponding to one of the two data items to be multiplied is set to the first state, the flag corresponding to a memory area in which data after the computations is to be stored is set to the first state.

5. The digital data decompressing system according to claim 2, including an arithmetic circuit for performing computations between data items stored in the memory areas, and a memory management unit for managing information for identifying plural memory areas in which the data items are stored, wherein, when two data items stored in the memory areas are to be added and the flag corresponding to one of the two data items to be added is set to the first state, identification information of a memory area set to a second state and identification information of a memory area in which data after computations is to be stored are exchanged with the flag, and the flag corresponding to a memory area in which data after computations has been stored as a result of an exchange is set to the second state.

6. The digital data decompressing system according to claim 2, including a fixed data output unit that, when data is to be read from the memory area with the flag set to the first state, outputs data of logical “0” instead of the data of the memory area.

7. The digital data decompressing system according to claim 2, wherein the digital data to be decompressed is an audio data.

8. The digital data decompressing system according to claim 2, wherein the digital data to be decompressed is an image data.

9. A digital data decompressing method in a digital data decompressing system that comprises plural memory areas in which decompressed data is stored, flags, provided so as to correspond one for one with the plural memory areas, which indicate whether stored data is all logical “0”s, and an arithmetic circuit for performing computations between data items stored in the memory areas, the method comprising the steps of:
inputting digital data compressed in compliance with a predetermined method as a bit stream of a proper format and performing the restoration of original data by decompressing the bit stream data; and
when two data items stored in the memory areas are added and the flag corresponding to one of the two data items to be added is set to a first state, reading data of another memory area whose flag is not set to the first state, storing the data of another memory area in a third memory area in which data after computations is to be stored, and setting the flag corresponding to the memory area to the second state.

10. A digital data decompressing method in a digital data decompressing system that comprises plural memory areas in which decompressed data is stored, flags, provided so as to correspond one for one with the plural memory areas, which indicate whether stored data is all logical “0”s, and an arithmetic circuit for performing computations between data items stored in the memory areas, the method comprising the steps of:
inputting digital data compressed in compliance with a predetermined method as a bit stream of a proper format and performing the restoration of original data by decompressing the bit stream data; and
when two data items stored in the memory areas are multiplied and the flag corresponding to one of the two data items to be multiplied is set to a first state, setting the flag corresponding to a third memory area in which data after multiplication is to be stored to the first state.

11. A digital data decompressing method in a digital data decompressing system that comprises plural memory areas in which decompressed data is stored, and flags, provided so as to correspond one for one with the plural memory areas, which indicate whether stored data is all logical “0”s, the method comprising the steps of:
inputting digital data compressed in compliance with a predetermined method as a bit stream of a proper format and performing the restoration of original data by decompressing the bit stream data;
whereas performing counting of the number of valid data, storing successively the valid data to be decompressed in the plural memory areas and setting the flags corresponding to the memory areas to the first state; and
when the valid data is exhausted, setting the flags corresponding to remaining memory areas in which data to be decoded is to be stored to a second state.
